(19) United States
(12) Patent Application Publication
(10) Pub. No.: US 2014/0267703 A1
(43) Pub. Date: Sep. 18, 2014

(54) Method and Apparatus of Mapping Landmark Position and Orientation

(71) Applicants: ROBERT M. TAYLOR, NEWARK, DE (US); ROBERT S. KUNZIG, ASTON, PA (US); LEONARD J. MAXWELL, NORTHEAST, MD (US)

(72) Inventors: ROBERT M. TAYLOR, NEWARK, DE (US); ROBERT S. KUNZIG, ASTON, PA (US); LEONARD J. MAXWELL, NORTHEAST, MD (US)

(21) Appl. No.: 13/841,568

(22) Filed: Mar. 15, 2013

(51) Int. Cl. G06T 7/00; G01B 11/14; H04N 7/18

(52) U.S. Cl. CPC G06T 7/004; H04N 7/18; G01B 11/14
USPC 348/139

(57) ABSTRACT

A method and apparatus for determining the location and orientation of landmarks in a coordinate space by identifying the landmarks, determining the location, size, and orientation of landmarks within the field of view of one or more cameras. The one or more camera's three-dimensional coordinate location(s) and orientation(s) are measured for each camera frame, and the landmark location(s) and orientation(s) are transformed into actual coordinates of the coordinate space. An identity, location, and orientation of each landmark is determined for each camera frame, and the multiple data values are stored in a database in a computer memory. Final landmark pose data are resolved by mathematically reducing the multiple location and orientation values for each landmark to single values. Landmark pose data are made available to position determination systems, navigation systems, or item tracking systems.

### FIELD OF THE INVENTION

The present invention relates to the determination of location and orientation of landmarks that are used by positioning systems, navigation systems, and location tracking systems. More specifically, the present invention determines the three dimensional location and orientation (called “pose”) of each landmark in its fixed location, whether indoors or outdoors.

### BACKGROUND OF THE INVENTION

Tracking the identity and location of physical assets, such as raw materials, semi-finished products and finished products, as they move through the supply chain is operationally imperative in many businesses. In material handling facilities such as factories, warehouses, and distribution centers, asset tracking is the primary task of a wide variety of systems, including inventory control systems, product tracking systems, and warehouse management systems, collectively termed “host systems.” The ability to determine the identity, position, and rotational orientation of assets within a defined coordinate space, with or without human interaction, is a practical problem that has seen many imperfect solutions.

Manual methods are often employed for the task of location determination. For example, barcode labels may be attached to storage locations. A warehouse may have rack storage positions, where each position is marked with a barcode label. To accomplish a material move, an operator may scan the rack label barcode and the item barcode when an item is deposited or removed. The two data may be uploaded to the host tracking system to record the material move.

In the case of bulk storage, where items are stored in open floor areas, items may be placed in any orientation without consistent physical separation. Floor markings—typically painted stripes called “slot lines”—are the conventional method of indicating storage locations and separating one location from another. Human readable text or bar code symbols may identify each slot location and the markings may be floor-mounted or suspended above storage positions.

Automated tracking systems have been in use for many years and are used widely today for their labor saving and accuracy benefits. Optical, ultrasonic, and radio technologies have been used to determine the position of objects indoors, where global navigation satellite systems (GNSS) or Global Positioning Systems (GPS) are unreliable. For example, a number of radio-based systems have been developed using spread spectrum RF technology, signal intensity triangulation, and Radio Frequency Identification (RFID) transponders, but all such systems remain somewhat subject to radio wave propagation issues and most provide location data, but lack orientation sensing. Typical of such RF technology is that described in U.S. Pat. No. 7,957,833, which is incorporated herein by specific reference for all purposes.

Ultrasonic methods can work well in unobstructed indoor areas, although sound waves are subject to reflections and attenuation problems much like radio waves. For example, U.S. Pat. No. 7,764,574, which is incorporated herein by specific reference for all purposes, claims a positioning system that includes ultrasonic satellites and a mobile receiver that receives ultrasonic signals from the satellites to recognize its current position. Similar to the GPS system in architecture, this positioning system provides position information but lacks orientation determination.

Optical methods have been used to track objects indoors with considerable success. For example, determining the location of moveable assets by first determining the location of the conveying vehicles may be accomplished by employing a vehicle position determining system. Such systems are available from a variety of commercial vendors, including, but not limited to, Sick AG of Waldkirch, Germany, and Kollmorgen Electro-Optical of Northampton, Mass. Laser positioning equipment may be attached to conveying vehicles to provide accurate vehicle position and heading information. These systems employ lasers that scan targets to calculate vehicle position and orientation (heading). System accuracy is suitable for tracking assets such as forklift trucks or for guiding automated vehicles indoors. This type of system presents certain limitations in bulk storage facilities where goods are stacked on the floor. Laser scanners rely on targets to be placed horizontally about the building at the altitude of the sensor. Goods stacked on the floor rising above the laser's horizontal scan line can obstruct the beam, resulting in navigation system failure.

Rotational orientation determination, which is not present in many position determination methods such as GPS, becomes especially important in applications such as vehicle tracking, vehicle guidance, and asset tracking. In materials handling applications, for example, items may be stored in particular orientations, with carton labels aligned in a certain direction or pallet openings aligned to facilitate lift truck access from a known direction. One method of tracking asset location and orientation is to determine the position and orientation of the conveying vehicle as it acquires and deposits assets. Having accurate orientation data for the vehicle allows the system to determine which storage area is being addressed, for example, the left versus the right side of the aisle. Physical proximity between the asset and the vehicle is assured by the vehicle's mechanical equipment; for example, as a forklift truck acquires a palletized unit load using a load handling mechanism.

Since goods may be stored in three-dimensional spaces with items stacked upon one another, or stored on racks at elevations above the ground or floor, a position and orientation determination system designed to track assets must provide position information in three dimensions and orientation. The close proximity of items also creates the problem of discriminating between assets in order to select the correct one. The combination of position determination, elevation determination and angular orientation determination and the ability to discriminate an item from nearby items is therefore desired.

A position and rotation determination method and apparatus are taught in U.S. patent application Ser. No. 11/292,463, now U.S. Pat. No. 7,845,560, titled “Method and Apparatus for Determining Position and Rotational Orientation of an Object.” Additional information is disclosed in U.S. Pat. No. 8,196,835 of the same title. Further, an improved position and rotation determination method is taught in a third application, U.S. patent application Ser. No. 12/807,325, now U.S. Pat. No. 8,381,982, “Method and Apparatus for Managing and Controlling Manned and Automated Utility Vehicles.” U.S. Pat. Nos. 7,845,560; 8,196,835; and 8,381,982; and U.S. patent application Ser. No. 12/807,325 are incorporated herein by specific reference for all purposes.

Another application, U.S. patent application Ser. No. 12/321,836, titled “Apparatus and Method for Asset Tracking,” (which is incorporated herein by specific reference for all purposes) describes an apparatus and method for tracking the location of one or more assets. The method comprises an integrated system that identifies an asset, determines the time the asset is acquired by a conveying vehicle, and determines the position, elevation and orientation of the asset at the moment it is acquired. It then determines the time the asset is deposited by the conveying vehicle, and determines the position, elevation and orientation of the asset at the time the asset is deposited. Each recording of position, elevation and orientation is made relative to a reference plane and a coordinate space.

Many types of landmarks may be used by position determination systems. A sophisticated use of position markers is disclosed in U.S. Pat. No. 6,556,722 (which is incorporated herein by specific reference for all purposes), wherein circular barcodes imprinted on flat surfaces and suspended above a coordinate space within a television studio serve as reference landmarks. In this optically based method, a studio television camera is equipped with a secondary camera which views landmarks set onto the studio ceiling in known locations. The markers are constructed of concentric ring barcodes that are developed specifically for the purpose. Camera position is determined by capturing an image of at least three markers and performing geometric analysis in a digital computer to determine accurate location within the three-dimensional studio space. Circular ring barcodes cannot be read by commercial machine vision systems, and camera images require a multiplicity of markers to be within view. Both limitations represent practical drawbacks for general purpose position determination systems.

U.S. Pat. No. 8,210,435, incorporated herein by specific reference for all purposes, discloses a landmark design called “optical position markers”, that overcome the limitations of U.S. Pat. No. 6,556,722 by using standard barcode symbols and more sophisticated image processing. Used herein, the terms “optical position marker”, “position marker”, “marker”, and “landmark” are interchangeable, with “landmark” being the general term for a fixed position reference, and all other terms indicating certain landmark designs.

The methods of these patent applications are useful for determining the position and orientation, or “pose” of an object or a conveying vehicle. However, what is needed is a method and apparatus to determine the pose of the reference landmarks used by such applications.

### SUMMARY OF THE INVENTION

In various exemplary embodiments, the present invention comprises a method and apparatus for determining the location (i.e., position) and orientation of landmarks in a coordinate space by identifying the landmarks, spatially discriminating landmarks from nearby ones, determining the location, size, and orientation of landmarks within the field of view of one or more cameras. Camera image data is transformed into actual coordinates of the coordinate space by measuring and recording the camera's three-dimensional location and orientation for each frame of camera data. An identity, location, and orientation of each landmark are calculated for each camera frame and the data is stored in a database in a computer memory. Multiple location and orientation data for each landmark are mathematically reduced to single coordinate values of X, Y, Z, and orientation θ (theta) and stored. These data are made available to a position determination system, navigation system, or item tracking system that uses the landmarks as fixed geographic references.

In one exemplary embodiment, the present invention comprises a method for mapping a plurality of landmarks (e.g., optical position markers) in a coordinate space using a mapping apparatus. The apparatus comprises a wheeled platform, moveable along a platform centerline and having a first optical alignment arrangement for aligning the platform centerline with a first reference line in the coordinate space. A second optical alignment arrangement is provided for aligning the platform with a fixed reference point in the coordinate space. A distance measuring means, such as a rangefinder and an associated target, are provided for measuring the position of the platform along the first reference line. One or more landmark sensing cameras and an associated image processor are provided for imaging the landmarks and analyzing the acquired images.

In one embodiment, the method comprises the steps of:

a) positioning the platform at a first known position relative to the first reference line and relative to a fixed reference point within the coordinate space relative to the first reference line, the distance of the first reference line to the fixed object in the coordinate space being known,

b) aligning the platform relative to the first reference line and measuring the distance from the platform centerline to the first reference line,

c) using the distance measuring device to measure the distance from the platform in the first coordinate direction to a target point,

d) acquiring an image of one or more landmarks within view of the one or more cameras,

e) analyzing the acquired images with the image processor to determine the identity of each of the one or more landmarks, the location of the one or more landmarks and the rotational orientation of the one or more landmarks relative to the one or more cameras,

f) converting landmark data from coordinates relative to the one or more cameras to coordinates relative to the platform and averaging the landmark data for each landmark,

g) converting the averaged landmark data from coordinates relative to the platform to coordinates relative to the coordinate space and storing the identity, the location and orientation of the one or more landmarks in a memory in the image processor,

h) moving the platform in the first coordinate direction parallel to the first reference line while repeating steps c) through g) until a predetermined stopping point is reached,

i) establishing a new reference line at a predetermined distance from, and parallel to, the first reference line,

j) positioning the platform at a known position and aligning the platform relative to the new reference line, and

k) repeating steps c) through j) until all the landmarks in the coordinate space have been mapped.

The advantages and commercial benefits from the invention include a reduction in the time and cost required to perform a mapping, an increase in the quality of landmark mapping data in terms of higher resolution and better accuracy, an increase in the relational accuracy between landmarks and surrounding features, and a consequent reduction in the accuracy requirements for landmark installation. As an example, a previously used manually-based prior art method of individual landmark mapping typically consumed several weeks of effort by two workers to map a 500,000 square foot warehouse with 30,000 landmarks and 10,000 physical features. One embodiment of the present invention facilitates mapping a similar size facility in about two days. Mapping accuracy, which comprises data precision and absolute accuracy of the position and orientation of landmarks relative to the coordinate space, is improved as much as ten-fold over the prior art manual methods.

### BRIEF DESCRIPTION OF THE DRAWINGS

FIG. 1 shows an indoor area of a storage facility with rack and bulk storage.

FIG. 2 shows the apparatus of an embodiment of the present invention comprising a platform, wheeled cart, measurement devices, cameras, and computer.

FIG. 3 shows five laser devices mounted upon the cart.

FIG. 3A is a plan view of the cart with laser devices and three geometric axes noted.

FIG. 3B shows a rear view of the cart.

FIG. 4 illustrates the five laser beams.

FIG. 5 shows detailed components of a camera, including the field of view.

FIG. 6 shows a single landmark with identifying indicia, key points, and center and size indicated.

FIG. 7 shows two landmarks of the above type, each uniquely encoded and centerlines aligned.

FIG. 8 illustrates a section of an extended strip of landmarks, where each landmark is held in position by support cables.

FIG. 9 shows two rows (strips) of uniquely encoded landmarks.

FIG. 9A shows two landmark strips with the cart positioned below, and indicates overlapping fields of view of two cameras.

FIG. 9B shows a plurality of uniquely encoded landmarks positioned randomly above the cart.

FIG. 9C shows a plurality of landmarks positioned above the cart, with some landmarks uniquely encoded and others not encoded.

FIGS. 10 through 15 are flowcharts illustrating the steps of the mapping process.

FIG. 10 is a flowchart showing the overall process.

FIG. 10A shows the detailed procedure of the mapping process.

FIG. 10B shows data usage, wherein data for each landmark, each coordinate system physical feature, and a table of suspect data are uploaded to a host system.

FIG. 11 shows steps to create a database of coordinate system physical features.

FIG. 12 shows the procedure for cart set up and calibration.

FIG. 13 shows a software flow chart of the data collection process.

FIG. 14 shows a software flow chart of the transformation of landmark data from pixel coordinates into coordinate space coordinates for each camera image.

FIG. 15 shows a software flow chart of the data filtering and data reduction steps.

FIG. 16 shows an exemplary set of data from the Marker Pose database.

FIG. 17 is a simulated computer screen showing multiple frame data using graphic symbols for each of six landmarks.

### DETAILED DESCRIPTION OF EXEMPLARY EMBODIMENTS

In several exemplary embodiments, the present invention comprises a method of mapping a coordinate space using the principles of technology known as Simultaneous Localization And Mapping (SLAM), but with certain constraints, features, and additional sophistication. The present method and apparatus creates a so-called “landmark map” in a computer database that is usable by the systems of the above-related applications, which are intended to track objects such as vehicles and stored goods within an indoor facility such as a warehouse or factory. Each of these related applications requires a plurality of uniquely encoded landmarks or “optical position markers” arranged at predetermined known positional locations.

In one embodiment, the method of the present invention constrains the motion of a sensing apparatus to a straight line, typically one coordinate axis of a platform, as it is moved through a coordinate space. One or more cameras detect landmarks of predetermined size, shape, contrast, or other identifying features. Image processing software determines the identity, location, and orientation of each landmark in the one or more camera's field of view. The location and orientation of the platform on which the one or more camera(s) is mounted are measured at the moment each image is captured. The present method and apparatus differs from most SLAM systems, in that multiple images are captured for each landmark and a large database is created. Computation of the landmark location and orientation in coordinate space coordinates is made with very high accuracy by analyzing the image data and reducing a multiplicity of data values to single values of location and orientation for each landmark.

SLAM is a relatively new technique used by robots and automated guided vehicles to build either a map of an unknown environment, or to modify, supplement, or correct a map of a known environment. For example, a remotely controlled vehicle may be guided into an unknown area such as a battlefield to map the geography and artifacts of that area without presenting danger to a vehicle operator. In another use, an autonomous vehicle may be employed to survey and map the interior of a building, such as a school or warehouse.

SLAM systems typically identify specific objects in a camera image to determine the object's position and orientation relative to a coordinate system. For outdoor environments, the coordinate system may be global latitude and longitude. The coordinate system for an indoor environment may be a de facto building reference based on roof support posts, concrete floor seams, or exterior walls.

An example of a commercial SLAM system for indoor use is offered by Applanix Corporation (Sunnyvale, Calif.). The apparatus, called a “Trimble Indoor Mobile Mapping Solution” (TIMMS), is based on a moveable cart with motion encoding devices attached to the wheels, three-dimensional laser range finding devices using Light Detection And Ranging (LIDAR) technology, and a multiplicity of vision systems (electronic cameras) to capture images of an exterior or interior space. LIDAR is an optical remote sensing technology that can measure the distance to a target by illuminating the target with light, often using very short duration light bursts from a laser. In this example, the TIMMS cart motion is detected by wheel and steering motion encoders, the LIDAR measures distances to surrounding objects in three dimensions, and the cameras simultaneously capture images of the surroundings. A map of the explored environment is made from the combination of all data, with video images or still images supplementing the measured distances.

The purpose of most SLAM implementations is to detect and record the proximity and form factor of objects in an interior or exterior space. It is useful to define a coordinate system for the coordinate space before SLAM recordings are made, although a coordinate system may be later overlaid on the obtained positional data. While a SLAM system typically creates a lower precision general map of all landmarks with accompanying video or photo evidence, the present invention maps the precise location of certain landmarks by analyzing iterative camera frames.

Images from which the position and orientation of an object can be determined may be a single image captured by a camera, a pair of images captured simultaneously by a pair of cameras, possibly in stereo-vision, or a sequence of images taken as a camera(s) moves in a known direction at a known speed or from a first known position to a second known position. Objects detected in the images may have unknown features (e.g., objects in a debris field), or they may be known objects such as position landmarks, sometimes known as “optical position markers”.

Image analysis may include several steps of transformation (i.e., conversion) and interpretation in order for camera data to be interpreted in coordinates of the chosen coordinate system. A number of analytic and geometric methods can be applied. For example, if a camera is calibrated in position and orientation in relation to the transport means, then the mapping of three-dimensional objects in the scene is possible by analyzing the two-dimensional data (pixels) of the camera image. Similarly, if the geometry of the object is known, the captured image of the object can reveal the object's pose.

In one particular embodiment, the method and apparatus of the present invention utilizes a system comprised of a set of hardware components and associated software, called a Calibration Cart (“CalCart”), that cooperate to provide a means for semi-automating the task of mapping landmarks and other features in a coordinate system to create a landmark database. This database may be used by the methods and apparatus of the above referenced patents and patent applications, such as U.S. Pat. No. 7,845,560. Mapping includes geographic definition of “real” locations and the corresponding landmark positions and orientations in the same coordinate system. The intent of the calibration cart is to reduce the amount of time, effort, complexity and cost, as compared to conventional manual methods, that is required for the preparation of data tables for positioning systems, and to improve the accuracy of the position and orientation data for landmarks and facility features (indoors) or land features (outdoors).

The CalCart operates in a mode where one axis of cart motion is typically fixed or controlled (relative to the chosen coordinate system) and the other two variable axes are measured in real time and synchronized with the recording of camera images, or frames. The known coordinates of the cart are then used to determine the location of the landmarks imaged by the cameras for every image frame. While a SLAM system typically creates a lower precision general map of all landmarks with accompanying video or photo evidence, the present invention maps the precise location of certain landmarks by analyzing iterative camera frames.

In one exemplary embodiment, the present invention determines the location and orientation of landmarks in a coordinate space by identifying the landmarks, spatially discriminating landmarks from nearby ones, and determines the position, size, and orientation of landmarks within the field of view of one or more cameras. Camera data is transformed into “real” coordinates of the coordinate space by storing the camera's three-dimensional location and orientation at the moment each frame of camera data is captured. A landmark's identity may be decoded by reading identifying indicia if identity is directly encoded, or an identity may be assigned to a landmark whose identity is not encoded.

Image processing software performs several functions, such as locating image artifacts that are determined to be landmarks, decoding identity data if it is visibly present on a landmark, and detecting the pixel position and orientation of each detected landmark. The data collection process must record landmark size along with the image data. This may be accomplished by either manually entering data to correlate each landmark identity with its size, by calculating landmark size from image data, or by calculating the closest match among a list of sizes entered during project setup. For each camera image (frame) the location and orientation of each landmark are stored in a database in a computer memory for further processing. Location and orientation data are then mathematically analyzed, producing averages, weighted averages, and standard deviations of the pose data, which are recorded for each landmark. The results of the analysis is a “reduced” data comprising a single value for each axis of the coordinate system (e.g.; X, Y, and Z), and one value of orientation (i.e.; theta, θ, which is rotation about the Z-axis) for each landmark. A set of reduced data for all landmarks in the coordinate space is made available to any position determination system that utilizes the landmarks as fixed geographic references.

It is generally accepted that landmarks appearing in a camera image (single frame) nearest to the center of the camera field of view offer the most reliable calculation of pose data into single values of X, Y, Z, and theta. On the other hand landmarks appearing in a camera image away from the center of the field of view offer a less accurate indication of the actual position and orientation of the landmark. When multiple images of the same landmark are captured, the data from these multiple images may be combined and analyzed to create a single pose dataset for the landmark that is more accurate than any single image can provide. Weighting factors may be applied to landmark data from each image during the data reduction process in order to minimize or compensate for optical variables such as lens distortion. For landmarks appearing in an image near the center of the field of view a high weighting factor is typically applied. For landmarks appearing in an image away from the center of the field of view a lower weighting factor is applied, the weighting factor being a function of the distance between the center of the landmark and the center of the image.

The weighting of a multiplicity of pose data for a single camera image (frame) may be done in several ways. For example, the distance, measured in pixels, between the center of a landmark and the center of the camera field of view may be calculated. Data wherein the landmark center is nearest to the center of the field of view of the camera would be accorded the highest weighting factor in the average for that landmark.

An alternative method takes into consideration landmark physical size and apparent size. Each landmark in an image has a particular size 70E measured in pixels. Physical landmark size may or may not be known. The cross dimension of the landmark is used to define a unit of “landmark size” or “landmark dimension”. The distance between the center of a landmark and the center of the camera field of view is measured in units of landmark size. A landmark appearing just one “landmark dimension” away from the field of view center would be given higher weight than a landmark detected in the image four “landmark dimensions” away from center. For example, landmark “000123” in FIG. 9B is larger than landmark “31150”. However, landmark “000123” lies farther (about 5 landmark dimensions) from the field of view center while landmark “31150” lies a multiple of three (of its own) landmark dimensions from the field of view center. When averaging data from this camera frame with data from other camera frames, landmark “31150” pose data would be given a relatively high weight, whereas landmark “00123” pose data would be given a lower weight. This method allows the system to weight landmarks of differing physical size and differing apparent size with different scaling factors.

It should be noted that any of the above methods may also be applied to calculations of position and orientation made by the position determination system for which landmark mapping is done.

In practice, the method may be used indoors or outdoors. It may be used to map landmarks of a particular design, or to map visible features of varying design. The apparatus may be configured in any of several ways to achieve the desired mapping purpose. The example used herein illustrates the mapping of encoded landmarks such as the “optical position markers” of U.S. Pat. No. 8,210,435. Each landmark has its identity encoded in the form of visible indicia. Bar codes are used in the example.

### The Apparatus

An exemplary embodiment is illustrated in FIG. 1, which shows an area of a storage facility with rack storage 80 and bulk storage denoted by storage slot lines 95. A wheeled platform 50 is shown facing down an aisle 90, positioned between a rack 80 (to the left) and slot lines 95 (to the right), and with a reflective optical target 60 placed at the aisle end. For clarity of illustration, only two rows of landmarks 70 are shown overhead the aisle and two other rows of landmarks are shown above the aisle to the left side of the figure. Landmarks are typically placed well above all operational storage areas (including slots defined by slot lines 95), so they do not interfere with facility operations.

Datum point 75A, which is a corner of the storage area, is a candidate reference datum for the mapping process. Other candidate datum points 75B, 75C, and 75D may be chosen; for example, the lower corners of rack support structure where steel uprights contact the floor. A single datum may be chosen for the coordinate system, or multiple datums may be chosen, with one reference point for each mapping run.

The embodiment described herein assumes landmarks are installed in the coordinate space above the cart; for example, on the roof trusses. It must be noted that the invention operates equally well to map floor-installed landmarks by mounting the cameras and laser plumb bob such that the cameras view downward and the laser plumb bob beam can impinge the floor or ground.

### The Cart and the X, Y, Z Axes

Referring to FIG. 2, the apparatus and the axes are defined. The cart X-axis is defined to lie along the cart's path of motion. The cart Y-axis is perpendicular to the X-axis and transverse to the cart's motion. The Z-axis is orthogonal to X and Y, denoting the third dimension above and below the cart.

The cart axes and the coordinate system axes may be orthogonally aligned or superimposed in order to simplify data transformations and the operator interface. If axes are so aligned during mapping setup and preparation, the cart will then operate on one of four cardinal orientations relative to the coordinate space coordinates. Theoretically, cart coordinates may be set to any arbitrary orientation relative to coordinate space coordinates; however, the preferred embodiment assumes cart alignment with one of four cardinal orientations: zero, ninety, one hundred eighty, or two hundred seventy degrees relative to coordinate space coordinates.

The physical apparatus comprises a platform 1, mounted on a wheeled cart 2, with necessary measurement devices, cameras 3 (left) and 4 (right), lasers 14, 15, 16, 18, a vertically oriented laser plumb bob 17, and computer 5 mounted aboard. A leveling plate 6 with leveling screws 7 and bubble level 8 mounted thereon is used to assure precise leveling of the cameras during cart calibration. A combined accelerometer/inclinometer device 9 is used to determine leveling plate inclination due to cart roll, pitch, and yaw, and to detect cart accelerations due to starts, stops, and bumps. Cart reference datum 10 is marked on the cart 2 in a known position. A ruler 11 is attached to the leveling plate, and is used to determine the position of the beam of vertically oriented laser plumb bob 17, which may be placed anywhere on the leveling plate surface. A tilt plate 12 is mounted to the right (or alternatively the left) side of the cart, and is able to swivel around the X-axis maintaining alignment with the X-axis and providing variable positioning of the relative resulting laser line L16 to the Y-axis. A self-contained power supply 13 is kept inside the cart for powering all devices. An encoder 19 may be attached to a wheel of the platform for measuring distance traveled by the platform. For simplicity of illustration the encoder 19 is located behind a wheel and is not visible in FIG. 2.

The Calibration Cart chassis has been specifically designed to mount all operational components and assist the user in keeping the cart moving straight ahead during mapping runs. The cart is designed with four precision wheels for forward motion and an elevating stanchion 76 (FIG. 3B) which facilitates the cart being slightly lifted, rotationally adjusted, and pre-positioned for alignment with the first straight reference line.

Although one or more cameras may be used, as illustrated the cart is provided with two cameras which provide cross-checking of landmark mapping for all landmarks visible in the overlapped fields of view. Data from each camera must agree in order for the data to be acceptable. The camera pair also facilitates cart calibration and simultaneous stereo vision.

A wide variety of commercial vision systems may be used; for example, “In-Sight Model 7010” from Cognex Corporation, One Vision Drive, Natick Mass. The present invention uses custom cameras which were specifically designed for the purpose.

Accelerometer/inclinometer data are recorded during mapping runs in order to more accurately calculate landmark positions by measuring floor or ground variations which cause camera tilt and pitch during the mapping run. An integrated accelerometer/inclinometer is available from SparkFun Electronics of Boulder, Colo. as Model ADXL345 accelerometer with Model ITG-3200 gyro attached.

The Calibration Cart has a portable power supply 13. An “NPower 1800USB” available from Northern Tool Corporation of Burnsville, Minn. is suitable, and will provide approximately eight hours of operation when fully charged from a standard AC power outlet. The cart facilitates rapid power supply change-out so that a backup can be kept on charge while the operational power supply is in use.

The Cart utilizes a conventional laptop computer for data collection, analysis and storage. In one embodiment, the software runs under Windows 7 and uses the Microsoft .NET (“dot net”) software framework. Other operating systems may be used for alternative embodiments.

Details of five laser devices are shown in FIG. 3. Lasers 14 through 18 are mounted on the cart in such a way that the position and orientation of each is carefully controlled. They are typically mounted orthogonally to one another. Laser 14 is a fixed beam laser pointing to the right of the cart along the cart's Y-axis. Its beam is denoted as L14.

Laser 15 creates fan-shaped beam L15, aimed directly in front of the cart and parallel to the cart's center line and X-axis. Beam L15 is preferably aimed at the floor directly along the cart's centerline. Laser 16 is mounted on a tilt-able plate creating a fan-shaped beam L16 along the floor to the right side of the cart with the beam parallel to the cart X-axis. Laser 17 is a plumb bob with beam L17 pointed directly overhead and directly below the device, with the lower beam spot impinging ruler 11. Laser 18 is a distance measuring device, i.e., a laser rangefinder, capable of accurately determining the distance to a reflective surface, typically located near the far end of the coordinate space and ahead of the cart's path. Laser 18 beam L18 points ahead of the cart, parallel to the cart X-axis. The distant surface may be a building wall if sufficient reflectivity exists, or it may be specially designed target 60. Point 60P is the point of impingement of laser beam L18 on target 60.

Lasers and laser measurement devices are available from many suppliers. In the example and the preferred embodiment, Laser 14 is a fixed beam laser such as Model GM-CF02 manufactured by Apinex of Montreal, Canada. Lasers 15 and 16 sweep fan-shaped patterns along a single axis, painting visible lines of light on the floor or ground. These are available as Model AGLL2 also from Apinex Corporation. Laser 17 is a plumb bob with beams exiting opposite ends of the device; one aimed downward toward the leveling plate surface, and the other aimed upward toward overhead landmarks. The beams are held vertical by gravity. The example uses a FATMAX Model 77-189 from Stanley Tools/Black and Decker of New Britain, Conn. Laser 18 is a distance measuring device based on a visible laser. Acuity Model AR1000 is used in the example. Acuity lasers are sold by Schmitt Industries of Portland, Oreg.

FIG. 3A shows a plan view of the cart with laser devices and three geometric axes noted. The distance between the moveable Laser 16 beam fan L16, and the fixed Laser 15 beam fan L15, which lies parallel to the cart center, is noted as dimension L15-L16.

Four of the five laser beams are used during a mapping run, with laser plumb bob 17 not normally needed after cart calibration. As shown in FIGS. 3, 3A, and 4, Laser 14 points beam L14 to the right of the cart, where structures such as building posts 74 (FIG. 4) or storage racks may lie. At the beginning of a run, beam L14 is used to align the cart to a known reference point already included in coordinate space database 250 (FIG. 10B). For example, if building post 74 is chosen as a reference, then reference point 75E and the distance between beam L15 and reference point 75E would be recorded to fix the cart's position along the “Y” axis.

Storage racks may be present along the right side of the cart during a mapping run within a warehouse aisle, with the rack support uprights spaced from three feet to twelve feet apart, and a typical spacing of about eight feet. The cart's position is always known during the mapping run; therefore, beam L14 should impinge upon a rack upright every eighth foot of cart travel. Beam L14 would normally be aligned with one of the rack uprights included as a reference in the coordinate database 250 at the beginning of a run. While beam L14 is aligned to the reference, the distance of L18 is measured. Then at any instance during the run the precise position of the cart is known since L16 is kept aligned and orthogonal to the reference and the current distance of L18 is compared to the distance of L18 when L14 was aligned to the selected reference.

Laser 15 sweeps beam L15 ahead of the cart and parallel to the cart reference line to provide a convenient means for measuring the distance between the cart reference and the building reference that beam L14 was aligned with at the beginning of the run (see FIG. 4). The cart may be aligned with a physical structure such as a floor joint or parking lot curb (or alternatively on overhead building structure) to give the mapping operator visible structure for beam L15 or L16 alignment. It should be noted that this physical structure represents a “first straight reference line”. FIG. 4 illustrates beam L16 aligned with the ends of slot lines 95. The dimension between the slot line ends and building post 74 (reference point 75E) is known; therefore the slot line ends define a first reference line.

Laser 16 sweeps beam L16 along the cart's right (as shown in FIGS. 3, 3A, and 4) or left side. It may be adjusted by swinging tilt plate 12 such that beam L16 intersects the “first straight reference line”; i.e., the physical structure described above.

Laser 17 points beam L17 overhead toward a landmark during pre-run calibration, and it may be used during a mapping run to verify a landmark center or physical structure location.

As illustrated, Laser 18 is implemented as a laser rangefinder. Laser 18 aims beam L18 forward along the aisle and parallel to the cart X-axis. The beam is typically aimed toward the approximate center of a reflective target in order to measure distance to the target. The laser beam spot 60P formed by beam L18 may vary in its height above the floor or ground as undulations cause the cart to be tilted slightly around the Y-axis. Beam spot 60P, also referred to as Target Point 60P, may also serve as a reference to assist the operator to maintain X-axis alignment. In another implementation (not illustrated), Target 60 may include sensors to determine the position of the L18 beam spot 60P impingement on the target. Correction signals may be fed back wirelessly to computer 5 to record or correct for cart tilt.

Many different types of measuring devices may be used for the purpose of determining cart-to-target distance. The laser applied in this example provides excellent accuracy and convenient use.

FIG. 3B provides a view of the cart from behind, showing lifting stanchion 76, which is used to lift the cart slightly for re-positioning during cart preparation for a mapping run. As an option, heated well 5B (or “heat pit”) is provided to keep computer 5 at a moderate operating temperature when mapping cold areas such as food storage freezers or refrigerated buildings. Computer screen 5A (also shown in FIG. 17) serves as the primary operator output interface and data display.

### The Target

A reflective surface is required by Laser 18 (beam L18) in order for distance measurements to be made. Ideally, a building wall may be used, as it typically defines a coordinate space boundary. Alternatively, a special reflective optical target 60 (FIGS. 1, 4) may be provided. Range finder laser beam L18 should be aimed toward the center of the target surface. Reflective target 60 typically provides a flat white surface for distances of less than 100 feet, and a retro-reflective surface for distances beyond about 100 feet in order to accommodate Laser 18 dynamic operating range. The target of the preferred embodiment provides two different reflective surfaces (one on the front and one on the back) that can rotate 180 degrees while maintaining their distance to Laser 18 when surfaces need to be changed during a mapping run.

### The Imaging Device(s)

In the illustrated embodiment, digital cameras are used to image the landmarks and the images are processed to determine the position and orientation of the landmarks. Other alternative technologies for landmark position measurement, such as LIDAR, may be used. FIG. 5 shows a perspective view of Camera 4 with lens 4A, illumination sources 4B, electronic circuit board 4C, and field of view 4D depicted by dashed lines. Similarly, Camera 3 has lens 3A, illumination sources 3B, electronic circuit board 3C, and field of view 3D. For drawing clarity these components are not shown. Each camera views directly overhead, with careful alignment to the laser plumb bob 17 and cart Z-axis. A camera field of view may be square (as shown), rectangular, or circular.

### The Landmarks

Landmarks may be specifically designed to be used with a certain positioning system. In one embodiment, the landmarks are placed overhead a coordinate space or working area and attached to overhead support structure, such as a roof truss, which is sufficiently high above the working area so as not to interfere with operations. In other embodiment, landmarks may be placed in other locations, including floors, walls, and other structures. The landmark apparatus comprises a plurality of tags, being grouped in one or more rows, each row having an axis, the tags in a row being supported by a row support. Each landmark (“marker”) tag comprises an optically opaque, dark colored corrugated substrate, substantially rectangular in shape. An adhesive-backed label having a unique machine-readable barcode symbol printed thereon is positioned centrally on the substrate so that a dark colored border of the substrate surrounds the label. Each row support comprises a first support cord and a second support cord. A spreader bar (not illustrated in FIG. 8) may be provided at each end of the support cords to establish a fixed spacing of the support cords corresponding to the spacing of the first and second lateral edges of the marker tags, thus preventing the application of lateral forces to the substrates.

Such an arrangement has been used successfully to identify positional locations within a coordinate space. The technology also applies to outdoor usage. Machine-readable barcode symbologies or other optically detectable features may be embossed, printed, or overlaid on each landmark to facilitate unique identification.

A single landmark 70 with identifying indicia is shown in FIG. 6. This example shows a (fictitious) Datamatrix-like barcode symbol with its three Key Points 70A, 70B, and 70C. All three points are detected by image processing software and their pixel coordinates in the camera's field of view are determined. The distance measured in pixels between Key Pont 70A and Key Point 70B defines the marker size 70E. A line drawn diagonally between Key Point 70A and Key Point 70C and bisected gives the marker center 70D, again in pixel coordinates.

A wide variety of standardized or custom barcodes may be used as indicia. While the example shows Datamatrix-style symbols, other barcode types may serve the purpose of encoding the landmark identity (ID), location, orientation, or other factors important to the associated positioning system or tracking system.

A small section of a landmark strip with two landmarks 70 is shown in FIG. 7. Each landmark is uniquely encoded, visible by the different black and white barcode patterns, but the centers and orientation may be readily determined using the geometry depicted in FIG. 6. The CalCart uses the calculations related to FIG. 6 to determine the centers of each landmark during a mapping run.

A larger section of a landmark strip 72 is illustrated in FIG. 8. Each landmark 70 is held in position by support cables 71 which are affixed to indoor or outdoor structure. The cables hold landmarks in approximate alignment along a row.

FIG. 9 shows a plan view of two rows (strips) of uniquely encoded landmarks, with the identity of each labeled in quotation marks. By choice, the landmarks are consistently oriented and sequentially numbered along each strip, with each landmark identity encoded by a two-dimensional barcode. This illustration will be used as a reference in FIG. 17.

FIG. 9A is a plan view of the two strips of encoded landmarks of FIG. 9, with the cart positioned below the strips. Camera 3 field of view 3D is shown by dotted lines and Camera 4 field of view 4D is shown by dashed lines. The fields of view may overlap one another, as shown in the illustration.

FIG. 9B is a similar view, but where encoded landmarks are randomly positioned, with random orientation and random identity. The camera fields of view cover the width of the landmark array as the cart proceeds forward along its direction of travel. All encoded landmarks can therefore be identified, decoded, and their size, orientation and position calculated during a mapping run. Some landmarks fall within the overlapped fields of view, allowing data cross-check.

Landmarks lacking unique identity may also be mapped by this method and apparatus. FIG. 9C illustrates an example where non-unique geometric shapes 73A, 73B, and 73C may mark positions and identify orientations, yet lack encoded identity. The mapping process may incorporate these landmarks in the database by assigning a unique identity to each based on its position. Image processing software is programmed to recognize the shape, and determine the size, and preferably the orientation, of the landmark within the field of view.

Landmarks are also known in the machine vision industry as fiducials. FIG. 9C presents three non-uniquely encoded landmarks of ordinary types; acute triangle 73A, “T”-shaped fiducial 73B, and “L”-shaped fiducial 73C. Machine vision techniques implemented in camera software or computer software identify uniquely shaped objects in a field of view, separate one from another, and perform measurements on each. Landmark shape factors such as area, perimeter, chord, or axes, may be determined by the software in order to locate a non-encoded landmark in the field of view and determine its orientation. In this way, non-uniquely encoded landmarks may still be found in an image, their position and orientation determined, and an identity assigned by the computer, typically in a sequential number assignment fashion.

### The Method—The Mapping Process

FIGS. 10 through 15 illustrate the mapping process using flow charts. FIG. 10 shows the overall process, which begins 100 with the creation of database 200 of coordinate space reference features such as corners of walls, building column (roof post) centers, corner points of storage areas, and any fixed references intended to be included in the map. All features are defined in three dimensions of the coordinate space. Calibration Cart 50, with all devices attached, is set up and calibrated 300 to assure that the devices are functioning properly and aligned as later detailed. Once calibrated, the cart may be used to begin the mapping process; it may not require recalibration during mapping of an entire coordinate space.

To prepare for a mapping run, the cart 50 is positioned in a known location and orientation 400 relative to a fixed reference; for example, using coordinate space features data (see FIG. 10A or 10B, item 250), and its position is then recorded. For example the X, Y cart location could be found according to FIG. 4 by aligning laser beam L14 to building support column 74 and measuring the distance between laser beams L15 and L16, with L16 aligned to ends of slot lines 95, where the distance from the slot line ends to building post 74 (reference point 75E) is known.

To finalize the software setup, an initial reading of distance-to-target is made by laser rangefinder 18. The software determines the cart's absolute position by a) reading the laser rangefinder to measure relative-X movement, and b) assuming that there is no relative Y-axis movement. The operator is now free to move the cart away from the starting point while keeping it aligned to the first reference line, which is typically aligned parallel to one of the coordinate space cardinal axes.

As a second alternative, the cart position may be referenced to a single datum of the coordinate space such as datum 75A (FIGS. 1, 4). A third alternative is to position the cart relative to a different datum for each mapping run. Choices may be made of building structure (75B, 75C, 75D in FIG. 1), or outdoor structure such as parking lot lines or lamp posts.

The cart is then moved along the cart X-axis, for example, an area of the coordinate space such as a warehouse aisle while keeping laser beam L16 aligned to the “first straight reference line”. By preference, the cart movement along its forward X-axis, which is parallel to the reference line, may have the cart X-axis and the reference line both being parallel to the coordinate space X-axis. By aligning the cart axis with the coordinate space axis the process is simplified for the operator and for the ensuing geometric calculations.

In the example shown in FIG. 4, Laser 16 fan-shaped beam L16 is shown aligned to slot line ends, such that the beam traces a line on the floor that becomes the “first straight reference line” for that mapping run. Note that the “first straight reference line” is not necessarily a physical entity, but may be defined by a set of points which create a temporary axis of alignment during the run such as the feet of rack posts or a construction seam in the floor.

The platform 1 is moved along its centerline and toward the rangefinder target 60 while maintaining parallel alignment between the second fan shaped laser beam L16 and the first straight reference line. The cart may be moved by a human operator, as shown in the illustrations, or it may be self-propelled, with human guidance or automated guidance.

Image data, rangefinder data, and accelerometer/inclinometer data are recorded 500 in synchronism with each camera frame. Step 600 provides data conversion from camera frame data (pixels) into coordinate space coordinates for each data record. Data are analyzed and reduced 700 to yield “Landmark ID, X, Y, Z, and theta, θ Data” 800, and “Suspect Landmark Data” 745.

If raw data or reduced data are not satisfactory (785, No) to within pre-established limits, the same area is mapped again (795, then 400). Remapping of a short section of a run may be required during the run for a number of reasons. For example, should the accelerometer indicate a sudden jolt such as the cart hitting a bump or crack in the floor or ground, the operator may be warned of the event and mapping may be automatically paused. If the rangefinder indicates a sudden distance excursion, such as when an object momentarily blocks the laser beam, or if the inclinometer indicates excessive tilt (leveling plate roll, pitch, yaw), mapping may be paused and an area repeated.

If data are satisfactory to within established limits (785, Yes), then mapping proceeds. An operator decision is made 790 to determine if all areas of the coordinate space have been mapped. If all areas have not been mapped (790, No), the cart is relocated to an unmapped area 850 and mapping continues 400. If all areas have been mapped (790, Yes), then the process is complete 900.

A more detailed process for step 500 is shown in FIG. 10A. As described above, the process begins 100 with the creation 200 of the coordinate space feature database 250, which contains important structures in X, Y, and Z coordinates. The cart is set up and calibrated 300 and positioned in a known location and orientation 400. As the cart is moved along one axis, shown as the X-axis in all figures, image data and cart position data are repetitively recorded 501, producing database 560 “Cart X, Y, Z, orientation θ (theta) Position Data in Coordinate Space Coordinates for Each Frame”, database 550 “Landmark ID and Orientation, Size, Position in Pixel Coordinates for Each Frame”, and database 570 “Rangefinder, Accelerometer and Inclinometer Data for Each Frame”. Dotted box 500 indicates the overall data collection process that occurs during each mapping run. While the run is in progress, landmark frame data are converted into coordinate space coordinates 600 and database 675 is created with landmark identity (“ID”), X, Y, Z, orientation θ (theta) data for each frame in coordinate space coordinates.

When the mapping run is complete, data 675 are analyzed and reduced 700 to become final “Landmark ID, X, Y, Z, orientation θ (theta) Data” 800 and/or “Suspect Landmark Data” 745. Each landmark ID, X, Y, Z, and orientation θ (theta) are reduced from a multiplicity of data to single values. Suspect landmark data are those that did not meet acceptable consistency criteria, which will be described herein.

Mapping is repeated 850 for all desired areas of the coordinate space and the process ends at step 900.

Data usage is shown in FIG. 10B. Once all mapping runs are complete and the entire coordinate space has been mapped with acceptable data, the coordinate space features X, Y, Z database 250, the landmark ID, X, Y, Z, orientation θ (theta) database 800, and the suspect landmark database 745 are transferred to the internal storage of host system 1000. In this example, the host system is a position and orientation determination system such as that described in U.S. Pat. No. 7,845,560.

FIG. 11 details the creation of the coordinate space features X, Y, Z, database. At the beginning 200 of the mapping process, important coordinate space features are identified, typically by the mapping operator. Features such as building structure (walls, office areas, aisles, etc.) or outdoor features (light poles, parking lot lines, trees, etc.) are manually mapped in X, Y, and Z coordinates, where the reference point may be a single point in the coordinate space, chosen 205 as the datum 75. This point may be a corner of a building or a prominent point outdoors. Multiple reference points may also be used. For example, storage rack structure may be used as a reference point for each mapping run. Key features are delineated 210 and the X, Y, and Z coordinates for each point are determined 215 relative to datum 75A, 75B, 75C, or 75D. Data are then stored in the coordinate space features X, Y, Z, database 250 and made available to the mapping process. This sub-process ends at step 225.

FIG. 12 details the cart set up and calibration. Beginning at step 300, a positional reference datum 10 (FIGS. 2, 3A) is chosen 305 for the cart. This may be a corner of the platform or its center. All five lasers are adjusted 310 for parallel alignment to the cart axes and their positions are measured and recorded.

All measurement devices are carefully calibrated by the manufacturer or by the user prior to installation on the cart. For example, cameras may be calibrated in the laboratory following assembly to assure that the lens, lens mount, camera body, imaging chip, and so forth meet factory specifications, or that compensation is recorded for lens distortion and other manufacturing or assembly variations.

Camera positions are measured with respect to cart datum 10, and their positions are recorded for future use in database 320, “Camera Positions Relative to Cart”. The cart is then moved to an area of the coordinate space where a landmark can be readily viewed overhead. The cart is carefully lined up 325 with the landmark (FIG. 4, 70) such that the Laser Plumb Bob 17 points vertically to the center of the landmark. Cart position and orientation are adjusted so that Laser 17 remains under the landmark while its downward beam points to the center of ruler 11 or some linear offset from center. The cart is now aligned in a known position beneath a landmark. The position of the cart within the coordinate space is not relevant during the calibration process; the process is used to adjust the imaging device mount parameters so that the position of the landmark being used for calibration is correct in cart coordinates.

The cameras then record images of the landmark. Image analysis determines the center of the chosen landmark for each camera, and Database 335 is created to record landmark center coordinates X and Y in pixels for each camera. These data are known as “camera offsets” which are unique to the two cameras, their lenses, mounting, and so on, thus accommodating compensation for minor camera position measurement error in cart X, Y, Z, yaw, pitch, and roll. Camera mounting parameters as they were manually measured in Step 310 may now be modified based on landmark image data until the calculated landmark position matches the projected point of the landmark onto the cart. The process ends at step 340, and may not be needed again during the mapping process.

### The Mapping Run

A data collection process is performed during a mapping run as the cart moves along its X-axis. One or more cameras may be used to capture images. The process begins on FIG. 13 at Step 502 with a single frame of video being captured 505 and stored momentarily in camera electronics. It is expected that all images will have one or more landmarks 70 in the field of view; however, in the case that no landmarks are present, the image is discarded and another image acquired. The image is searched 506 using image processing software to determine if any landmarks are present. If no landmarks are present (506, No), another image is captured 505. If a landmark is present (506, Yes) the landmark(s) is located in the image 510 and Laser Rangefinder 18 simultaneously measures 515 the distance to the Target. The target, known as the “associated target”, may be a distant wall, reflective object, or something specially designed for the purpose such as Target 60.

The inclinometer measures cart tilt 513 along the cart roll, pitch, and yaw axes in synchronism with the capturing of a camera image (frame). The accelerometer synchronously measures 521 the cart acceleration, and all values are stored momentarily by computer 5. A test is made 518 on the derivative of rangefinder data, inclinometer, and accelerometer data to determine whether all data lie within limits established prior to the mapping run.

If any data falls outside limits (518, No), data collection is paused and the operator is notified 519. The mapping process restarts at step 502 on the operator's command. If all data is within limits (518, Yes) the cart X position can be calculated 516 from rangefinder data and cart position based on the reference chosen at the beginning of the run, cart tilt can be stored 514, and cart acceleration (the second derivative of cart position) can be stored 517.

Step 511 tests whether the marker contains an encoded identity, such as a barcode. If the landmark does not contain an encoded identity (511, No), an “assigned identity” is given 512 and passed to the Landmark ID database 525. Identity assignment is done by control computer 5, which handles and stores all data except image processing, which is done within the camera software. If the landmark does contain an encoded identity (511, Yes), the identity is decoded 520 and the landmark ID is stored in database 525.

The cart's position is calculated in coordinate space X-, Y-, Z-, and orientation θ (theta) coordinates in step 530 and stored in database 560, which contains the cart pose for each camera frame.

Accelerometer data and inclinometer data stored synchronously 570 with rangefinder measurements allow landmark position calculations to be adjusted for cart pitch, roll, and yaw caused floor or ground undulations.

A final image processing step determines 535 the relative position, orientation, and size of the landmark(s) within the image, and these data are stored in database 550 along with landmark ID. Thus, databases 550, 560 and 570 have all data necessary to subsequently determine the landmark position in coordinate space coordinates.

### Data Conversion

Landmark data are converted from pixel coordinates into cart coordinates for each camera image (frame). This occurs in step 610 on FIG. 14. The process starts 600 by retrieving databases for Camera X, Y Offsets in Pixels (335), Landmark ID and Orientation, Size, Position in Pixel Coordinates for Each Frame (550) and Camera Position(s) (320). Next, conversion is made 620 from cart coordinates to coordinate space coordinates. This conversion requires retrieving Cart Y, Z and orientation θ (theta) in Coordinate Space Coordinates for Each Frame (560) and Rangefinder, Accelerometer and Inclinometer Data (Tilt) for Each Frame (570). Accelerometer/Inclinometer “tilt” contains cart roll, pitch, yaw, and acceleration values at the moment the frame is acquired. Inclinometer compensation is optional and dependent on floor or ground flatness of the area being mapped. The output from the process is database 675 of landmark ID, X, Y, Z, and orientation θ (theta) in coordinate space coordinates for each camera frame.

Multiple camera frames are recorded for each landmark. As the cart moves along the forward direction, each camera records images at a typical rate of five or more frames per second; therefore, many frames may be recorded for each landmark, with each frame taken at a slightly different cart position.

Either landmark size or landmark height above the reference plane (floor or ground) may be known in advance. Landmark height Z may be calculated based on its size in the image if its physical size is known. For example, time-lapsed stereoscopic vision (using a single camera to take successive images of a landmark at different camera positions) may be used to determine landmark height Z and position if neither height nor size are known. Alternatively, landmark height may be known in advance if landmark size is unknown. By measuring and recording the angle between the marker center and the center of the camera field of view, trigonometry can be used to calculate the distance between the marker and the center of the camera lens in coordinate space coordinates. The “time-lapsed stereo vision” method can determine the height of the marker without the physical marker size or its height being known prior to starting a mapping run.

In order to reduce the data to a single value of X, Y, Z and orientation θ (theta) for each landmark, process 700 (FIG. 15) starts by filtering “flier” data at step 705. Database 675 is the input. The filtering process will be detailed in FIG. 16. Filtered data 710 is used to then calculate the average position of each landmark by averaging 715 all filtered data for that landmark and storing the results in database 720. This process is also described below.

An acceptability limit is chosen 725 for the evaluation of data consistency, and this becomes a threshold value to test landmark data consistency mathematically. A calculation of standard deviation is made 730 for each axis for each landmark, and tested 735 to determine if deviation is acceptable. If the deviation exceeds acceptable limits (735, Yes) the X, Y, Z, and theta, θ coordinates and the average and standard deviation data are recorded 740 for future use. This creates a table of suspect landmark data 745.

If the standard deviation for a landmark does not exceed limits (735, No), the averaged X, Y, Z, and Theta, θ data are recorded 755 in database 800. The sequence of steps 725, 730, and 735 perform the test shown as “Are Data Satisfactory?” (step 785 on FIG. 10).

A test 760 is made to determine if all landmarks in the mapping run have been processed. If not (760, No), the next landmark is evaluated 730. If all landmarks have been analyzed (760, Yes), the data analysis process ends for this run at step 780 and proceeds to step 850 on FIG. 10.

### Example Data

FIG. 16 shows an exemplary set of data from database 675, “Landmark ID, X, Y, Z, Theta, θ Data for Each Frame in Coordinate Space Coordinates”. Referring to the table, sample frame 1 is acquired by a camera at time 13:44:05.1, when a landmark was found in the field of view and decoded as 62747. Upon transforming the pixel coordinates into coordinate space coordinates (Step 600), the landmark's calculated X position is 14410, the Y position is 7619, and the Z position is 6140, with all positions expressed in millimeters relative to the chosen datum for this mapping run. The calculated orientation with respect to the coordinate system is 91 degrees.

At sample frame 2, which is acquired two tenths of a second later, the cart has moved into a new location along the X-axis; however the transformed positions of the same landmark are just slightly different at X=14411, Y=7620, Z=6142, and Theta, θ is 90 degrees.

Camera frames are acquired every two tenths of a second and transformed into coordinate space coordinate data until frame 11, when the camera no longer sees landmark 62747 and begins to view a landmark that decodes as 31150.

At frame 7, however, the X position suddenly changes by a substantial amount. The difference between the calculated position in frame 6 (14409) and the position in frame 7 (2206) is 12,203 millimeters. Frame 7 would imply that the cart moved more than 12 meters in two tenths of a second; a physical impossibility. Frame 8 also presents suspect data. Frame 9 once again shows the landmark X position to be about 14412, which is consistent with earlier data from frames 1 through 6.

Data from Frames 7 and 8 are therefore discarded as “fliers”. Many variables may have caused the bad data, and in this case, an object such as a worker or a forklift truck passed in front of the laser rangefinder L18 beam, which caused the laser to read distance-to-object instead of distance-to-target. By measuring and monitoring the instantaneous derivative of the laser rangefinder 18 signal and pausing the recording process when the absolute value of the derivative exceeds a threshold, a data “flier” of any cause may be detected.

In practice and by operator choice, sudden distance changes in the laser range finder output may cause the data collection process to automatically pause, requiring operator intervention to resume data collection. Similarly, an accelerometer output indicating a bump or crack in the floor or ground causes the data collection process to automatically pause, requiring operator intervention to resume data collection. It is left to the operator to determine the cause of such data collection interruptions and to proceed accordingly.

Removing the two “fliers” and performing the calculation of the standard deviation (FIG. 15, Step 730) for the X-axis data for landmark 62747 gives the following:

“Average” is equal to the sum of all valid data divided by the number of data points:

Average=(14410+14411+14410+14407+14411+14409+14412+14410)/8=14410.0

“Deviation” is equal to the difference between the average and the value of each data point that diverges from the average:

Deviation=0,+1,0,−3,+1,−1,+2,0 (i.e.; five data points deviate from the average)

“Standard Deviation” is equal to the square root of the sum of the squares of the deviation:

Sum of the Squares={0²+1²+0²+(−3)²+1²+(−1)²+2²+0²}=16

Standard Deviation=Square Root(16/8)=Square Root(2.0)=1.41 millimeters.

By assuming for this example that a standard deviation threshold of 5 millimeters is acceptable (FIG. 15, Step 725) for each landmark, the X coordinate value data passes the acceptance test and is used as final data for the landmark position. A similar procedure is performed on the Y-axis, Z-axis, and Theta, θ data for this landmark.

FIG. 17 shows a simulated screen shot from computer 5. It may be useful to the mapping operator to visualize mapping data on the computer screen in order to obtain quick feedback of the quality of the mapping run data. Consistent data would encourage the operator to continue with the run; divergent data might suggest a momentary stop to make adjustments.

Frame data 675 is shown on computer screen 5A in FIG. 17, with the graphics depicting five frames each of six landmarks. The landmarks are illustrated in FIGS. 9 and 9A. Each landmark is depicted using a graphic symbol; each symbol is created by software as a square indicating landmark size and position. Orientation (theta, θ) is indicated graphically by a line drawn from the landmark center toward the orientation direction.

When overlaid one frame upon another, each set of squares visually presents the conformity of data for that landmark. For example, five frames of data 675A reveal fair consistency; 675B shows data for that landmark to be more consistent (less deviation), and 675C shows less consistency (more deviation). Graphical representation aids the operator in quickly verifying data quality as the mapping run proceeds. A similar graphical method can be used to show the discrepancies between mapping run results for each landmark. The operator may decide to include or exclude particular landmark data, or to include or exclude entire mapping runs based on the interpretation of graphical depiction of data.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A method of mapping a plurality of landmarks in a coordinate space, comprising the steps of:
moving a mobile platform with one or more imaging devices along a first reference line within said coordinate space;
acquiring one or more images of one or more landmarks within said coordinate space;
determining the distance of the mobile platform from a fixed target point for each image acquired; and
analyzing, using a computer processor or microprocessor, the one or more acquired images to identify the location and orientation of said one or more landmarks relative to the one or more imaging devices.

2. The method of claim 1, wherein the location and orientation of said one or more landmarks are converted to a location and orientation in relation to said mobile platform.

3. The method of claim 1, further comprising the step of determining the location coordinates and rotational orientation of said one or more landmarks within said coordinate space.

4. The method of claim 1, wherein the mobile platform is wheeled.

5. The method of claim 1, wherein the location and orientation identifications are stored in a computer memory.

6. The method of claim 1, wherein the mobile platform has a first optical alignment arrangement for aligning a centerline of the mobile platform relative to said first reference line in a first coordinate direction, and a second optical alignment arrangement for aligning the mobile platform with a fixed object in a second coordinate direction.

7. The method of claim 1, wherein the step of determining the distance comprises measuring the position of the mobile platform with a distance measuring device mounted on the mobile platform.

8. The method of claim 1, wherein the step of determining the distance comprises measuring the position of the mobile platform with a distance measuring device mounted adjacent to a coordinate space boundary.

9. The method of claim 7, wherein the distance measuring device comprises a laser rangefinder.

10. The method of claim 7, wherein the mobile platform is wheeled, and the distance measuring device comprises an encoder attached to a wheel on the mobile platform.

11. The method of claim 1, wherein the mobile platform is continually moving during acquisition of said one or more images.

12. The method of claim 1, wherein the mobile platform moves between image acquisition points, and stops during acquisition of said one or more images.

13. The method of claim 6, wherein the distance is known between the first reference line and a known facility reference point.

14. The method of claim 6, further comprising the step of measuring the distance from the first reference line to the mobile platform centerline.

15. The method of claim 1, further comprising the step of determining the coordinates and rotational orientation of said one or more landmarks within said coordinate space.

16. The method of claim 15, wherein the step of determining the coordinates and rotational orientation of said one or more landmarks within said coordinate space comprises the steps of:
determining the coordinates and rotational orientation of said one or more landmarks relative to the one or more imaging devices;
converting the coordinates and rotational orientation relative to the one or more imaging devices to coordinates and rotational orientation relative to the mobile platform; and
converting the coordinates and rotational orientation relative to the mobile platform to coordinates and rotational orientation relative to the coordinate space.

17. The method of claim 16, further comprising the step of averaging the coordinate and rotational orientation data determined for a particular landmark for each image in which said landmark appears.

18. The method of claim 16, further comprising the step of averaging the coordinate and rotational orientation data determined for a particular landmark for each image in which said landmark appears, wherein each data point is accorded a weighting factor which is a function of the distance between the center of the landmark and a center of each image in which said landmark appears.

19. The method of claim 17, wherein said mobile platform is moved until a predetermined stopping point is reached.

20. The method of claim 19, further comprising the steps of:
establishing a second reference line at a predetermined distance from, and parallel to, the first reference line; and
moving the platform along the second reference line while repeating the steps of image acquisition, distance determination, and image analysis.

21. The method of claim 1, wherein the landmarks are fiducials or barcodes placed within the coordinate space.

22. The method of claim 1, wherein the landmarks are uniquely encoded or identifiable.

23. The method of claim 1, wherein the coordinate space is inside a warehouse or storage facility.

24. The method of claim 23, wherein the landmarks are placed on the ceiling, walls, or floors of the warehouse or storage facility, or a combination thereof.

25. The method of claim 1, wherein the coordinate space is an outdoor area.

26. The method of claim 1, wherein the one or more imaging devices comprise one or more digital cameras.

27. A method of mapping a plurality of landmarks in a coordinate space, comprising the steps of:
acquiring, using one or more imaging devices on a mobile platform, a plurality of images of the plurality of landmarks while moving the platform through the coordinate space;
processing, using a computer processor or microprocessor, each image of the plurality of images to:
identify each landmark in the image;
determine the location of the center of each landmark within the image;
calculate the location of each landmark relative to the location of the mobile platform at the time the image was acquired;
determine the rotational orientation of each landmark relative to the mobile platform at the time the image was acquired; and
store, in a computer memory, the identity, location and rotational orientation of each landmark.

28. The method of claim 27, further comprising the steps of:
converting, using a computer processor or microprocessor, the landmark position data from coordinates relative to the platform to coordinates relative to the coordinate space; and
averaging the landmark position data for each landmark.

29. A system for mapping a plurality of landmarks at fixed locations in a coordinate space, comprising:
a mobile platform;
one or more imaging devices mounted in fixed locations on the mobile platform;
at least one distance-measuring device mounted in a fixed location on the mobile platform; and
a plurality of landmarks placed at fixed locations within the coordinate space;
wherein the one or more imaging devices are adapted to capture images of the plurality of landmarks as the mobile platform moves within the coordinate space.

30. The system of claim 29, wherein the mobile platform comprises a wheeled cart.

31. The system of claim 29, further comprising a plurality of lasers mounted in fixed locations on the mobile platform, wherein the plurality of lasers comprises:
a first reference laser;
a second reference laser aligned with the centerline of the platform, wherein the generated laser beam is fan-shaped;
a third reference laser, wherein the generated laser beam is fan-shaped; and
a fourth laser directed vertically.

32. The system of claim 29, further comprising a computing device with a processor or microprocessor, wherein said processor or microprocessor is adapted to analyze and process the captured images to determine the location and the rotational orientation of said landmarks.

33. The system of claim 29, further comprising an inclinometer mounted on the mobile platform.

34. The system of claim 29, further comprising an accelerometer mounted on the mobile platform.

35. A method of mapping a plurality of landmarks in a coordinate space, comprising the steps of:
moving a mobile platform with one or more landmark position measurement devices along a first reference line within said coordinate space;
performing a landmark position measurement of one or more landmarks within said coordinate space;
determining the distance of the mobile platform along the first reference line for each landmark position measurement performed; and
analyzing, using a computer processor or microprocessor, the one or more landmark position measurements to identify the location and orientation of said one or more landmarks relative to the one or more landmark position measurement devices.

36. The method of claim 35, wherein the mobile platform is continually moving during acquisition of said one or more landmark position measurements.

37. The method of claim 35, wherein the mobile platform moves between landmark measurement acquisition points, and stops during acquisition of said one or more landmark position measurements.
